(19) United States
(12) Patent Application Publication
(10) Pub. No.: US 2025/0209770 A1
(43) Pub. Date: Jun. 26, 2025

(54) COMPUTER SYSTEM, METHOD, AND PROGRAM

(71) Applicant: Sony Interactive Entertainment Inc., Tokyo (JP)

(72) Inventors: Tetsugo INADA, Tokyo (JP); Hiroyuki SEGAWA, Tokyo (JP)

(73) Assignee: Sony Interactive Entertainment Inc., Tokyo (JP)

(21) Appl. No.: 18/847,695

(22) PCT Filed: Mar. 29, 2022
(86) PCT No.: PCT/JP2022/015510

§ 371 Date: Sep. 17, 2024

(51) Int. Cl. G06V 10/147; G06V 10/764; H04N 25/47

(52) U.S. Cl. CPC G06V 10/147; G06V 10/764; H04N 25/47

(57) ABSTRACT

Disclosed is a computer system for recognizing an object. The computer system includes a memory for storing a program code and a processor for performing operations in accordance with the program code. The operations include acquiring information indicating the occurrence of vibration in the object and recognizing the object according to an event signal generated by an event-based vision sensor at the timing of the occurrence of the vibration.

### TECHNICAL FIELD

The present invention relates to a computer system, a method, and a program.

### BACKGROUND ART

There is known an event-based vision sensor in which event signals are asynchronously generated by pixels that detect a change in intensity of incident light, specifically, a change in luminance of a surface of a subject. The event-based vision sensor is advantageous in that it is able to operate at high speed with low power consumption compared to a frame-based vision sensor that scans all pixels at predetermined intervals, specifically an image sensor such as a CCD (charge coupled device) or CMOS (complementary metal-oxide-semiconductor) image sensor. Technologies related to the above-mentioned event-based vision sensor are described in, for example, PTL 1 and PTL 2.

### CITATION LIST

### Patent Literature

### [PTL 1]

JP 2014-535098T

### [PTL 2]

JP 2018-85725A

### SUMMARY

### Technical Problem

However, although the above-mentioned advantages of an event-based vision sensor are known, it cannot be said that sufficient peripheral technologies have been proposed in consideration of characteristics different from those of vision sensors in the past, such as a frame-based vision sensor.

Accordingly, the present invention aims to provide a computer system, a method, and a program that make it possible to generate useful information by recognizing vibrating objects according to event signals generated by an event-based vision sensor.

### Solution to Problem

According to an aspect of the present invention, there is provided a computer system for recognizing an object. The computer system includes a memory for storing a program code and a processor for performing operations according to the program code. The operations include acquiring information indicating occurrence of vibration in the object and recognizing the object according to an event signal generated by an event-based vision sensor at timing of the occurrence of the vibration.

According to another aspect of the present invention, there is provided a method of recognizing an object by allowing a processor to perform operations in accordance with a program code stored in a memory. The operations include acquiring information indicating occurrence of vibration in the object and recognizing the object according to an event signal generated by an event-based vision sensor at timing of the occurrence of the vibration.

According to yet another aspect of the present invention, there is provided a program for recognizing an object by allowing a processor to perform operations in accordance with the program. The operations include acquiring information indicating occurrence of vibration in the object and recognizing the object according to an event signal generated by an event-based vision sensor at timing of the occurrence of the vibration.

### BRIEF DESCRIPTION OF DRAWINGS

FIG. 1 is a diagram illustrating an example of a system according to a first embodiment of the present invention.

FIG. 2 is a diagram illustrating a device configuration of the system depicted in FIG. 1.

FIG. 3 is a flowchart illustrating a flow of processing performed by the system depicted in FIG. 1.

FIG. 4 is a flowchart illustrating another example of processing performed by the system depicted in FIG. 1.

FIG. 5 is a diagram illustrating an example of the system according to a second embodiment of the present invention.

FIG. 6 is a diagram illustrating a device configuration of the system depicted in FIG. 5.

FIG. 7 is a flowchart illustrating the flow of processing performed by the system depicted in FIG. 5.

### DESCRIPTION OF EMBODIMENTS

Embodiments of the present invention will now be described in detail with reference to the accompanying drawings. Incidentally, in this document and the accompanying drawings, component elements having substantially the same functional configurations are denoted by the same reference signs to avoid redundant descriptions.

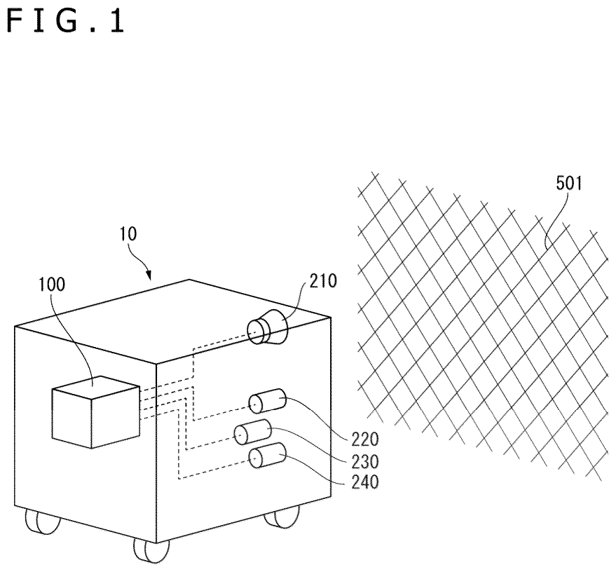

FIG. 1 is a diagram illustrating an example of a system according to a first embodiment of the present invention. In the illustrated example, the system is implemented as an autonomous mobile robot 10. The autonomous mobile robot 10 includes a computer 100, a speaker 210, an EVS (event-based vision sensor) 220, an RGB camera 230, and a dToF (direct Time of Flight) sensor 240. The computer 100 may be, for example, a processing circuit mounted in the autonomous mobile robot 10 or a PC (personal computer) or networked server device that remotely controls the autonomous mobile robot 10. The speaker 210 emits sound waves toward a space in which the EVS 220, the RGB camera 230, and the dToF sensor 240 perform measurements. It should be noted that component elements of the autonomous mobile robot 10 other than those mentioned above will not be described in detail because known technologies can be used.

In the above-described autonomous mobile robot 10, the speaker 210 is an example of a vibration device that vibrates an object 501 by emitting sound waves toward the object 501. When the object 501 vibrates, a position of the object 501 itself changes, or a positional relation between a light source and the surface of the object 501 changes, and thus causes a change in luminance. As a result, an event signal is generated by the EVS 220, which is directed toward the object 501. The object 501 can be recognized based on the generated event signal.

For instance, in a case where the object 501 is net-like as indicated in the example of FIG. 1, individual parts of the object 501 are thin. Therefore, while the object 501 is stationary, it may be difficult to recognize the object by using the event signal even if the EVS 220 mounted on the autonomous mobile robot 10 is moving. In such an instance, when the object 501 is vibrated by the sound waves emitted from the speaker 210, a luminance change occurs in a wider area that is obtained by adding an amplitude of the vibration to the original area of the object 501. This makes it easier to detect the object 501 by using the event signal, and makes it possible to perform a process, for example, of causing the autonomous mobile robot 10 to avoid the object 501 while moving.

Further, as indicated in a later-described example, in a case where it is not necessarily difficult to detect the object by using the event signal, a pattern of vibration applied by the speaker 210 can be compared with the amplitude of the vibration in the object, which is detected by the event signal, in order to recognize, for example, the physical properties of the object, such as material and rigidity, and select a process according to the individual physical properties. The sound waves emitted from the speaker 210 may be ultrasonic waves or sound waves in the audible range as long as they are capable of vibrating the object 501. Alternatively, in a case where a target object is prone to vibrate, such as a net-like or curtain-like object, a fan or other airflow generator may be used as the vibration device.

It should be noted that, in the example of FIG. 1, the speaker 210, the EVS 220, the RGB camera 230, and the dToF sensor 240 are disposed in close proximity to each other. Alternatively, however, for example, the speaker 210 and the other devices may be positioned apart from each other. For example, the speaker 210 may be fixedly disposed in a space in which the object 501 exists, instead of being mounted on the autonomous mobile robot 10, and information indicating that the object 501 is being vibrated by the speaker 210 may be inputted to the autonomous mobile robot 10. Further, the EVS 220, the RGB camera 230, and the dToF sensor 240 need not necessarily be disposed in close proximity to each other if the positional relation between them is known. Specifically, it is acceptable that the results obtained when object 501 is captured by the individual sensors can be associated with each other.

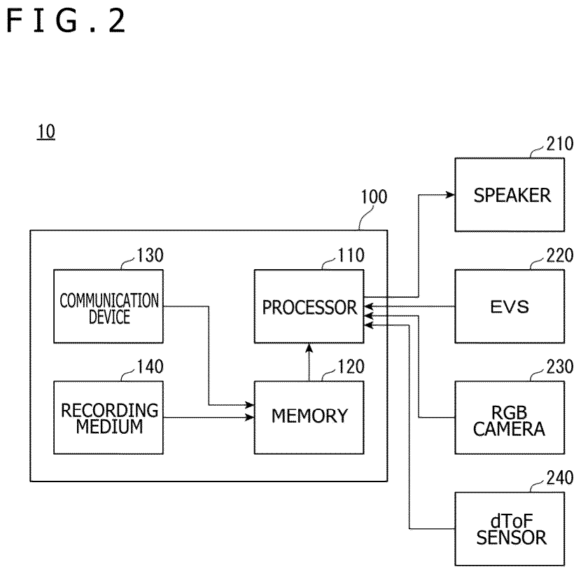

FIG. 2 is a diagram illustrating a device configuration of the system depicted in FIG. 1. The computer 100 includes a processor 110 and a memory 120. The processor 110 includes, for example, processing circuits such as a CPU (Central Processing Unit), a DSP (Digital Signal Processor), an ASIC (Application Specific Integrated Circuit), and/or an FPGA (Field-Programmable Gate Array). Further, the memory 120 includes storage devices such as various types of ROM (Read Only Memory), RAM (Random Access Memory), and/or HDD (Hard Disk Drive). The processor 110 operates in accordance with a program code stored in the memory 120. The computer 100 further includes a communication device 130 and a recording medium 140. For example, the program code for causing the processor 110 to operate in a manner described below may be received from an external device through the communication device 130, and stored in the memory 120. Alternatively, the program code may be read from the recording medium 140 and loaded into the memory 120. The recording medium 140 includes a removable recording medium, such as a semiconductor memory, a magnetic disk, an optical disk, or a magneto-optical disk, and a driver for the removable recording medium.

The speaker 210 emits sound waves according to a control signal inputted from the processor 110 of the computer 100. The EVS 220 is also called an EDS (Event Driven Sensor), an event camera, or a DVS (Dynamic Vision Sensor), and includes a sensor array equipped with sensors including light-receiving elements. When a sensor detects a change in the intensity of incident light, more specifically, a change in luminance, the EVS 220 generates an event signal including a timestamp, sensor identification information, and information regarding the polarity of the luminance change. Meanwhile, the RGB camera 230 includes a frame-based vision sensor, such as a CMOS image sensor or a CCD image sensor, and acquires an image including an object. The dToF sensor 240 includes a laser light source and a light-receiving element, and measures a time lag between the irradiation of laser light and the reception of reflected light. From the measured time lag, depth information regarding the object can be obtained.

In the first embodiment, a positional relation between the EVS 220, the RGB camera 230, and the dToF sensor 240 is known as mentioned above. That is, the sensors included in the sensor array of the EVS 220 are associated with pixels of an image acquired by the RGB camera 230. Further, target areas of the depth information regarding the object measured by the dToF sensor 240 are also associated with the pixels of the image acquired by the RGB camera 230. The processor 110 of the computer 100 temporally associates the outputs of the EVS 220, RGB camera 230, and dToF sensor 240 by using, for example, a timestamp given to each output. Meanwhile, a positional relation between the speaker 210 and the EVS 220 and a positional relation between the RGB camera 230 and the dToF sensor 240 need not necessarily be known. However, the timing when the object is vibrated by the sound waves emitted from the speaker 210 is known.

Specifically, for example, the processor 110 may identify the time when the sound waves are emitted from the speaker 210 as the timing when the object is vibrating, and process the outputs of the EVS 220, RGB camera 230, and dToF sensor 240 on the premise that the object is vibrating during such a period. In this case, the information indicating the occurrence of vibration in the object is information indicating that the speaker 210 is being driven. When the processor 110 itself drives the speaker 210, the information indicating the occurrence of vibration in the object is internally acquired by the processor 110 as the timing when a control signal is inputted to the speaker 210. Further, in this case, the timing when vibration has occurred in the object is any timing while the speaker 210 is being driven.

Alternatively, the processor 110 may calculate a delay time that occurs between emission of sound waves from the speaker 210 according to the depth information regarding the object measured by the dToF sensor 240 and (occurrence of) vibration of the object, and identify the timing of object vibration by adding the calculated delay time to the timing when the control signal is inputted to the speaker 210. Further, as indicated in a later-described example, when the sound waves are emitted from the speaker 210 in a plurality of different patterns, the processor 110 may identify the timing when the object vibrates in response to the sound waves of each of the different patterns, and perform different processes based on the state of object vibration in response to the sound waves of each of the different patterns. In these cases, the information indicating the occurrence of object vibration includes a timestamp of the time when the speaker 210 was driven. The processor 110 associates the timing of the occurrence of object vibration with the outputs of the sensors in a manner similar to the above-described manner of associating the outputs of the EVS 220, RGB camera 230, and dToF sensor 240.

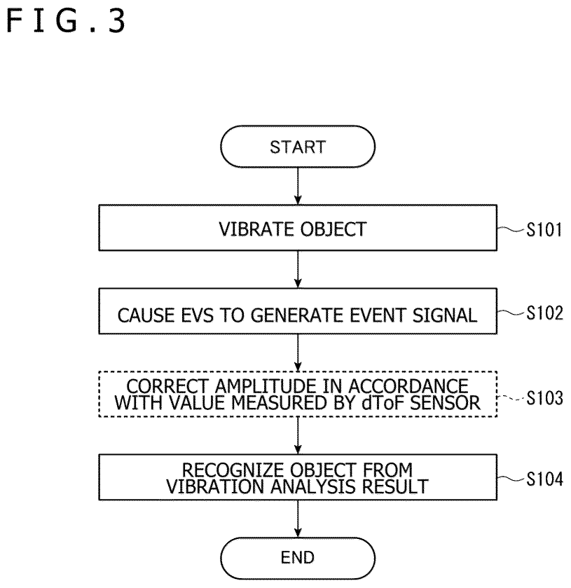

FIG. 3 is a flowchart illustrating the flow of processing performed by the system depicted in FIG. 1. In the example of FIG. 3, first of all, the processor 110 vibrates the object by emitting sound waves from the speaker 210, which is a vibration device (step S101). Specifically, the processor 110 drives the speaker 210 through appropriate driver software according to audio data stored in the memory 120. When the sound waves are emitted from the speaker 210, the object vibrates due to the collision between the object and the sound waves. As described earlier, the vibration in the object causes a change in the position of the object itself or in a positional relation between the light source and the surface of the object. This results in a luminance change, so that an event signal is generated by the EVS 220 directed toward the object (step S102).

In all the above cases, a change in the position of the object itself or object surface appears as vibration. Therefore, the amplitude and frequency of the vibration generated in the object can be identified based on the event signal. The processor 110 recognizes the object from the results of such vibration analysis (step S104). It should be noted that a specific example of object recognition will be described later. In this instance, the processor 110 may correct the amplitude of the vibration according to the depth information regarding the object measured by the dToF sensor 240 (step S103). Since a positional relation between the EVS 220 and the dToF sensor 240 is known as mentioned above, the depth information regarding the object, that is, the distance from the dToF sensor 240 to the object, can be converted to the distance from the EVS 220 to the object. If the distance from the EVS 220 to the object is known, it is possible to calculate the distance on the object that corresponds to the distance between the sensors at which the amplitude is observed.

As the simplest example of object recognition in step S104 above, the processor 110 may recognize the existence of the object itself. Such a recognition result can be used in a case where, for example, the autonomous mobile robot 10 detects an obstacle at the destination. In this case, in step S104 above, an area where vibrations of a predetermined amplitude or higher are observed through the use of the event signal is recognized as the area of the object. In this instance, in order to distinguish from an event that occurs in the entire field of view due to the movement of the autonomous mobile robot 10, for example, an area where vibrations are observed at a frequency corresponding to the frequency of sound waves emitted from the speaker 210 may be recognized as the area of the object. In such a case, when the object is to be recognized based on an event signal that is generated by the event-based vision sensor at the timing of the occurrence of object vibration, the timing of the occurrence of vibration need not necessarily be specifically identified, and there is no problem if the occurrence of object vibration is confirmed.

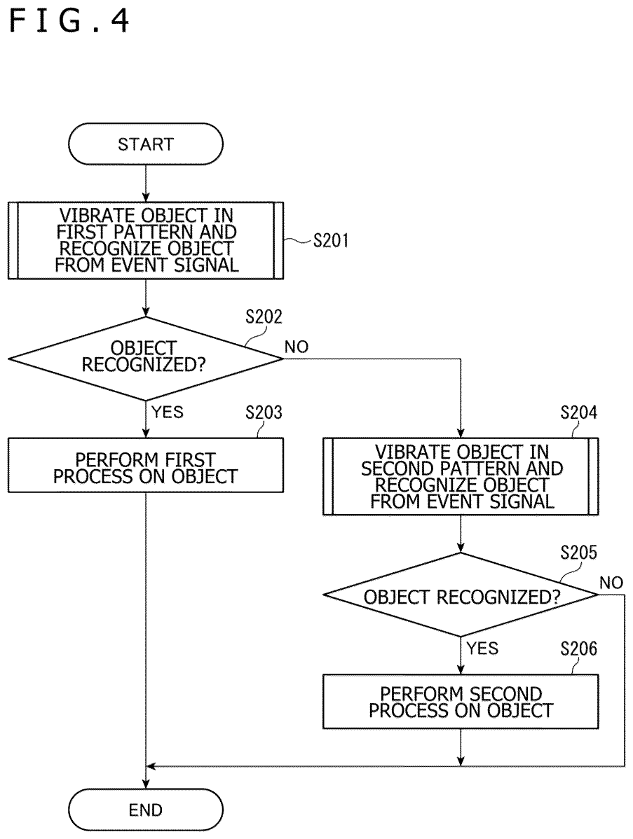

FIG. 4 is a flowchart illustrating another example of processing performed by the system depicted in FIG. 1. In the illustrated example, first of all, the system performs the processing of vibrating an object in a first pattern and recognizing the object from an event signal (step S201). This processing is a series of processes described above with reference, for example, to FIG. 3. In this case, in step S101 depicted in FIG. 3, the processor 110 drives the speaker 210 to emit sound waves of a predetermined frequency and a predetermined amplitude. Further, the processor 110 internally acquires information indicating that the speaker 210 is driven to vibrate the object in the first pattern, and recognizes the object according to the event signal generated at the timing of the occurrence of vibration in the first pattern. If the object is recognized by such processing in step S201 (“YES” in step S202), the processor 110 performs a first process on the object (step S203).

Meanwhile, if the object is not recognized by the processing in step S201 above (“NO” in step S202), the processor 110 performs the processing of vibrating the object in a second pattern and recognizing the object from the event signal (step S204). This processing is also a series of processes described above with reference, for example, to FIG. 3. In this case, in step S101 depicted in FIG. 3, the processor 110 drives the speaker 210 to emit sound waves that differ in at least one of frequency and amplitude from the case of the above-mentioned step S201. Further, the processor 110 internally acquires information indicating that the speaker 210 is driven to vibrate the object in the second pattern, and recognizes the object according to the event signal generated at the timing of the occurrence of vibration in the second pattern. If the object is recognized by such processing in step S204 (“YES” in step S205), the processor 110 performs a second process on the object (step S206). Note that object recognition in the above-mentioned steps S202 and S205 signifies that vibration of a predetermined amplitude or higher is observed, for example, in the area of the object through the use of the event signal.

In the above processing, either the first process or the second process is performed on the object according to at least one of a first recognition result derived from the vibration in the first pattern in step S201 and a second recognition result derived from the vibration in the second pattern in step S204. Specifically, if vibration of a predetermined amplitude or higher is observed in the first recognition result, the first process is performed without reference to the second recognition result (steps S201, S202, and S203 are performed). Meanwhile, if vibration of a predetermined amplitude or higher is not detected in the first recognition result and vibration of a predetermined amplitude or higher is detected in the second recognition result, the second process is performed with reference to both the first recognition result and the second recognition result (steps S201, S202, S204, S205, and S206 are performed). Further, if vibration of a predetermined amplitude or higher is not detected in either the first recognition result or the second recognition result, neither the first process nor the second process is performed (steps S201, S202, S204, and S205 are performed).

The first and second processes performed in the above steps S203 and S206, respectively, may be identical with or different from each other. In steps S201 and S204, when the object is vibrated at different frequencies and recognized due to vibration of one of the different frequencies, a common process may be performed, for example, to cause a moving autonomous mobile robot 10 to avoid the object as an obstacle. In this case, the first process and the second process are identical with each other. Since the frequency at which vibrations are likely to occur varies with the physical properties of the object, such as material and rigidity, the accuracy of object detection is improved by generating vibrations at two frequencies in the object.

Alternatively, the first process and the second process may be different from each other. For example, in a case where the autonomous mobile robot 10 avoids a hard object fixed on the ground while moving, and pushes aside a hanging soft object, such as a curtain, without avoiding it, one of the first and second processes may be an avoidance process and the other may not be an avoidance process. In the above case, in steps S201 and S204, vibrations of different frequencies may be generated by the same vibration device such as the speaker 210, or vibrations may be generated by different vibration devices. Specifically, for example, in step S201, the object may be vibrated by using an airflow generator such as a fan, and in step S204, the object may be vibrated by using ultrasonic waves emitted from the speaker 210. If vibration of a predetermined amplitude or higher is generated in the object by an airflow in step S201, the object may be determined to be soft and thus a process of not avoiding the object may be performed in step S203, and if vibration of a predetermined amplitude or higher is generated in the object by using ultrasonic waves in step S204, the object may be determined to be hard and thus a process of avoiding the object may be performed in step S206.

In the first embodiment of the present invention described above, a luminance change occurring upon object vibration is detected based on the event signal outputted from the EVS 220. The EVS 220 has a high temporal resolution. Therefore, if the area where the luminance change occurs due to the application of vibration is expanded, it becomes possible to recognize even a thin net-like object that is difficult to recognize with a frame-based vision sensor or an ultrasonic sensor that detects the reflection of ultrasonic waves. Further, when the EVS 220 is used, the latency between object vibration and object recognition is smaller than that when the frame-based vision sensor or the ultrasonic sensor is used. If a plurality of EVSs 220 are disposed in parallel to form a stereo EVS, it is also possible to detect a depth of the object without using a dToF sensor. Since the temporal resolution of the EVS 220 is, for example, on the order of microseconds, it is also possible to convert the sound waves emitted from the speaker 210 into ultrasonic waves and generate vibrations in the object without generating audible sounds. Alternatively, the speaker 210 may emit sound waves in the audible range to vibrate the object at the same time as, for example, reproducing music.

Incidentally, in the present embodiment, the system is implemented as the autonomous mobile robot 10. In another embodiment, however, the system may be implemented as a robot that does not autonomously move, or may alternatively be implemented as a device other than a robot.

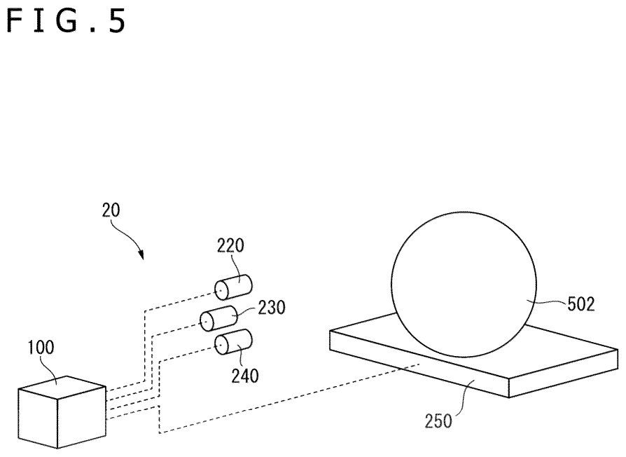

FIG. 5 is a diagram illustrating an example of the system according to a second embodiment of the present invention. In the illustrated example, the system is implemented as an analysis device 20. The analysis device 20 includes the computer 100, a vibration table 250, the EVS 220, the RGB camera 230, and the dToF sensor 240. The computer 100 is, for example, a PC or a networked server device. The vibration table 250 is a device capable of applying vibration to an object 502 placed on the vibration table by various methods such as an electric motor type, air type, or ultrasonic type method. The EVS 220 is disposed so as to capture a luminance change event occurring on the surface of the object 502 placed on the vibration table 250. Similarly, the RGB camera 230 is disposed so as to capture an image of the object 502. The dToF sensor 240 is disposed so as to be able to measure the depth to the object 502.

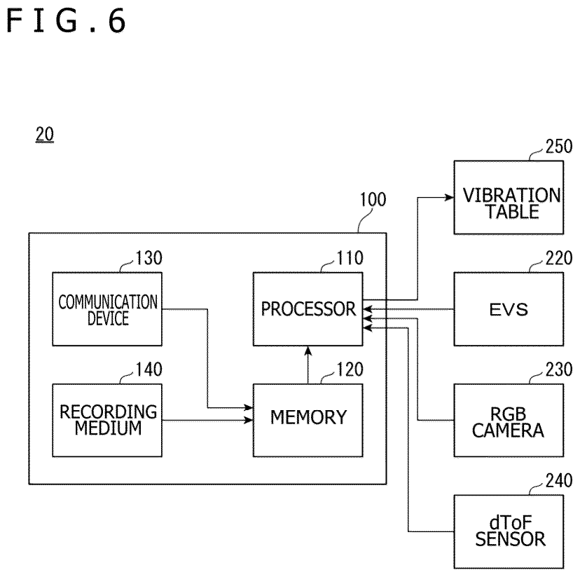

FIG. 6 is a diagram illustrating a device configuration of the system depicted in FIG. 5. The vibration table 250 is an example of a vibration device that generates vibration by contacting the object 502 placed on the vibration table 250 under the control of the processor 110 of the computer 100. For example, in a case where the EVS 220 and the vibration table 250 are fixedly disposed, the distance from the EVS 220 to the object 502 is known. Consequently, the analysis device 20 need not necessarily include the dToF sensor 240. In a case where either or both the EVS 220 and the vibration table 250 are movable, the analysis device 20 may calculate the distance from the EVS 220 to the object 502 according to the depth information regarding the object 502 measured by the dToF sensor 240. It should be noted that component elements other than those described above are the same as those described in conjunction with the first embodiment and will not be redundantly described.

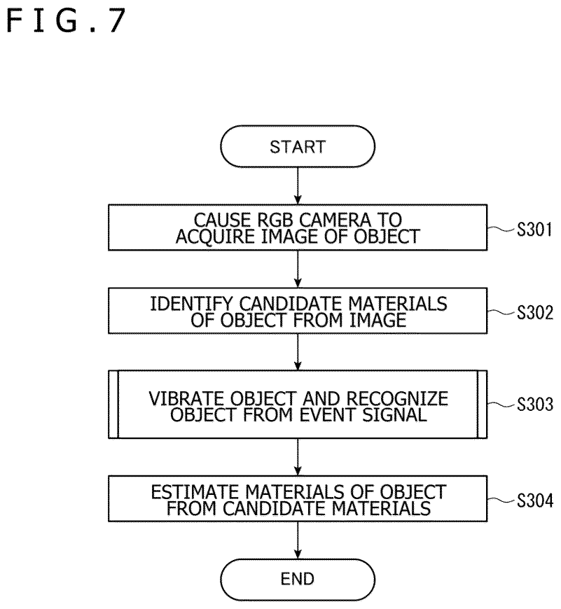

FIG. 7 is a flowchart illustrating the flow of processing performed by the system depicted in FIG. 5. In the example of FIG. 7, first of all, the RGB camera 230 acquires an image of the object 502 (step S301), and identifies candidate materials of the object by analyzing the acquired image through the use of a known image recognition technology (step S302). Specifically, the candidate materials may be identified on a rule base according to the shape of the object identified from the image analysis. In this case, if the shape of the object is, for example, “dish-shaped,” the candidate materials include, for example, ceramics, paper, plastic, and aluminum, but do not include stone, iron, or concrete. Alternatively, the candidate materials may be identified based on the image captured by the RGB camera 230 or metal reflectivity (Metalness) and coarseness (Roughness) measured by an unillustrated polarization sensor.

After the above-mentioned steps S301 and S302 or in parallel with these steps, the system performs a process of vibrating the object and recognizing the object from the event signal (step S303). This process is described as a process of generating vibrations in the object by using the vibration table 250 instead of the speaker in the series of processes described above with reference to, for example, FIG. 3. If, as indicated in step S103 of FIG. 3, the amplitude of the vibration is corrected based on the depth information regarding the object measured by the dToF sensor 240, the object can be recognized more accurately by comparing the amplitude of the vibration applied by the vibration table 250 with the absolute amount of the vibration in the object. As described above, if a positional relation between the EVS 220 and the object 502 placed on the vibration table 250 is known, the amplitude of the vibration may be corrected without using the dToF sensor. Based on the result of object recognition in step S303, the processor 110 estimates the material of the object from the candidate materials identified in the above-mentioned step S302 (step S304). The processing in step S304 is an example of an object recognition process that is similar to the processing in step S104 depicted in FIG. 3.

In the second embodiment of the present invention, which is described above, vibration is generated in the object 502 by using the vibration table 250, and a luminance change due to the vibration is detected based on the event signal outputted from the EVS 220. For example, the amplitude of the vibration is high if the object 502 is light, and is low if the object 502 is heavy. The accuracy of estimating the material according to the above-described vibration can be improved by identifying the shape of the object according to the image captured by the RGB camera 230 and extracting the candidate materials of an identified specific object (e.g., a dish).

It should be noted that a speaker described in conjunction with the first embodiment may be used instead of or in addition to the vibration table 250 in order to generate vibration in the object. When such a configuration is adopted, it is possible to estimate whether the surface of the object is hard or soft from the magnitude of the amplitude of the vibration generated by the sound waves. If the surface of the object is hard, the amplitude is high, and if the surface is soft, the amplitude is low. If the object is plain, it is difficult for a luminance change to occur due to vibration. However, in such a case, it is possible to detect the luminance change due to vibration by allowing a separately provided light source to irradiate infrared rays toward the object and by utilizing the EVS 220 capable of detecting infrared wavelengths.

In the present embodiment, the system is implemented as the analysis device 20. In another embodiment, however, the system may be assumed not to include a fixed installed component element such as a vibration table.

For example, the system according to the second embodiment may be implemented as an autonomous mobile robot that is described in conjunction with the first embodiment.

While the embodiments of the present invention have been described in detail above with reference to the accompanying drawings, the present invention is not limited to the above-described embodiments. It is obvious that persons having ordinary knowledge in the technical field to which the present invention belongs can conceive of various modifications and alterations within the scope of the technical ideas described in the appended claims. Further, it is to be understood that such modifications and alterations also definitely fall within the technical scope of the present invention.

### REFERENCE SIGNS LIST

10: Autonomous mobile robot
20: Analysis device
100: Computer
110: Processor
120: Memory
130: Communication device
140: Recording medium
210: Speaker
220: EVS
230: RGB camera
240: dToF sensor
250: Vibration table

1. A computer system for recognizing an object, the computer system comprising:
a memory for storing a program code; and
a processor for performing operations in accordance with the program code, wherein
the operations include
acquiring an event signal generated by an event-based vision sensor,
acquiring, separately from the event signal, information indicating occurrence of vibration in the object, and
recognizing the object according to the event signal that is generated by the event-based vision sensor at timing of the occurrence of the vibration.

2. The computer system according to claim 1, wherein
the operations further include inputting a control signal to a vibration device that generates the vibration in the object and
the timing of the occurrence of the vibration is identified based on timing when the control signal is inputted to the vibration device.

3. The computer system according to claim 1, wherein
the operations further include inputting a control signal to a vibration device that generates the vibration in the object, and
the information indicating the occurrence of vibration in the object is internally acquired as timing of input of the control signal.

4. The computer system according to claim 2, wherein
the vibration device generates the vibration by emitting sound waves toward the object.

5. The computer system according to claim 4, wherein
the timing of the occurrence of the vibration is identified by adding a delay time to the timing when the control signal is inputted to the vibration device.

6. The computer system according to claim 5, wherein
the delay time is calculated based on depth information regarding the object.

7. The computer system according to claim 2, wherein
the vibration device generates the vibration by contacting the object.

8. The computer system according to claim 1, wherein
the operations further include correcting an amplitude of the vibration that is detected based on the event signal, according to depth information regarding the object.

9. The computer system according to claim 1, wherein
recognition of the object includes estimating a material of the object.

10. The computer system according to claim 9, wherein
the operations further include identifying candidate materials of the object by analyzing an image acquired through use of a frame-based vision sensor, and
the material of the object is estimated from the candidate materials.

11. The computer system according to claim 1, wherein
information indicating the occurrence of the vibration in the object includes information indicating the occurrence of a first-pattern vibration in the object and information indicating the occurrence of a second-pattern vibration in the object,
the recognition of the object includes at least one of acquiring a first recognition result by recognizing the object according to an event signal generated at timing of the occurrence of the first-pattern vibration and acquiring a second recognition result by recognizing the object according to an event signal generated at timing of the occurrence of the second-pattern vibration, and
the operations further include performing either a first process or a second process on the object according to at least one of the first recognition result and the second recognition result.

12. A method of recognizing an object, the method comprising:
allowing a processor to perform operations in accordance with a program code stored in a memory, wherein
the operations include
acquiring an event signal that is generated by an event-based vision sensor,
acquiring, separately from the event signal, information indicating occurrence of vibration in the object, and
recognizing the object according to the event signal that is generated by the event-based vision sensor at timing of the occurrence of the vibration.

13. A program for recognizing an object, the program causing a processor to perform operations in accordance with the program, wherein
the operations include
acquiring an event signal that is generated by an event-based vision sensor,
acquiring, separately from the event signal, information indicating occurrence of vibration in the object, and
recognizing the object according to the event signal that is generated by the event-based vision sensor at timing of the occurrence of the vibration.
